(19) United States
(12) Patent Application Publication
(10) Pub. No.: US 2003/0102369 A1
(43) Pub. Date: Jun. 5, 2003

(54) Authenticating credit cards transactions

(76) Inventor: Rickey D. Clark, Galveston, TX (US)

Correspondence Address: TROP PRUNER & HU, PC, 8554 KATY FREEWAY, SUITE 100, HOUSTON, TX, 77024, US

(21) Appl. No.: 09/997,874

(22) Filed: Nov. 30, 2001

(51) Int. Cl. G06K 5/00

(52) U.S. Cl. 235/380

(57) ABSTRACT

More secure credit card transactions may involve receiving both the information conventionally encoded in a credit card and information provided separately by the credit card owner. The separate information may be in the form of a personal identification number which is separately provided by the credit card owner. If the encoded credit card information matches the prearranged personal identification number, the transaction is accepted and, otherwise, the transaction may be declined.

### BACKGROUND

This invention relates generally to the processing of credit card purchase transactions.

The widespread misuse of credit card information by thieves greatly increases the cost of credit card transactions (and perhaps purchases in general) for all consumers. One common source of credit card abuse is in connection with businesses, such as restaurants and nightclubs, wherein the credit card transaction is executed outside of the credit card owner's view. Thus, it is possible for a dishonest person to run the credit card one or more times without the user knowing. If desired, the credit card thief may forge the user's signature on duplicate charge slips using the actual transaction charge slip as a guide.

In a variety of other circumstances, thieves may gain access to either a credit card owner's credit card number, or the actual credit card itself. The only protection that the credit card issuer or the credit card owner may have, in some circumstances, is the signature requirement. Commonly the signature is on the back of the credit card and is therefore easily forged. If the signature is not on the back of the credit card, then any signature will suffice because the credit card processor has no way to verify the signature. In many transactions, no signature is even required.

While elaborate systems have been contemplated to combat credit card theft, most of these systems greatly increase the cost of credit card processing. As a result, these approaches have not been widely accepted.

Thus, there is a need for techniques which economically combat credit card misuse.

### BRIEF DESCRIPTION OF THE DRAWINGS

FIG. 1 is a front elevational view of a hand module in accordance with one embodiment of the present invention;

FIG. 2 is a front elevational view of a home base unit in accordance with one embodiment of the present invention;

FIG. 3 is a front elevational view of a home base unit in accordance with another embodiment of the present invention;

FIG. 4 is a schematic depiction of a network in accordance with one embodiment of the present invention for processing credit card transactions;

FIG. 5 is a schematic depiction of a hand module in accordance with one embodiment of the present invention;

FIG. 6 is a schematic depiction of a base unit in accordance with one embodiment of the present invention;

FIG. 7 is a flow chart for software used with the module shown in FIG. 5 in accordance with one embodiment of the present invention;

FIG. 8 is a flow chart for software utilized on the base unit of FIG. 6 in accordance with one embodiment of the present invention;

FIG. 9 is a flow chart for software that may be utilized by the credit processor in accordance with one embodiment of the present invention;

FIG. 10 is an end view of the embodiment shown in FIG. 1; and

FIG. 11 is an enlarged top plan view of a receptacle shown in FIG. 2 in accordance with one embodiment of the present invention.

### DETAILED DESCRIPTION

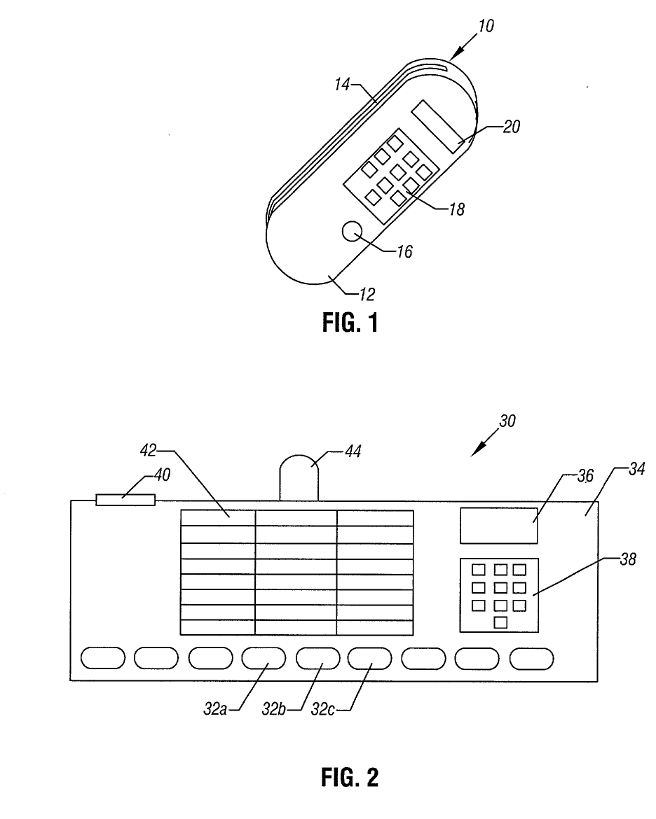

Referring to FIG. 1, the hand module 10 may be a portable, hand holdable, battery powered device in one embodiment. The hand module 10 may include a slot 14 to receive a credit card. When the credit card is swiped through the slot 14, information on the card's magnetic strip may be read by a reader within the hand module 10. The hand module 10 may also include a display screen 20, a plurality of numerical keys making up a keypad 18 and a start or “on” button 16, all contained on a housing 12 shaped to fit conveniently in the user's hand.

A multiple port home base unit 30, shown in FIG. 2, may include a plurality of receptacles 32 to plugingly receive the hand modules 10, in one embodiment. The housing 34 may also include a numeric keypad 38 in one embodiment and a screen 36, all defined in a housing 34. Also defined on the housing 34 are an input/output connector 40 to communicate with a network and a menu 42 providing information about available keypad codes. A printer 44 may be provided on the unit 30 in some embodiments.

In an example where the module 10 and base unit 30 are utilized in a restaurant environment, the hand module 10 may be provided to the restaurant patron for purposes of paying the restaurant bill. The restaurant patron may swipe his or her credit card through the slot 14. Thereafter the restaurant patron may enter a confidential personal identification number (PIN) using the keypad 18. As used herein a personal identification number is a numeric or non-numeric code assigned to an authorized credit card user. The confidential personal identification number may appear on the screen 20 or, for security purposes, may be blocked out on the screen 20 using asterisks.

Once the information has been entered, the module 10 may be returned to the waiter. The waiter may then take the module 10 and plug it into one of the receptacles 32 in the base unit 30.

When the module 10 is plugged into a receptacle 32, the contacts 15 on the bottom surface of the module 10 mate with the contacts 19 in the receptacle 32 allowing data to be exchanged as indicated in FIGS. 10 and 11. Similarly, power may be provided from the base unit 30 via the contacts 21 in the base unit 30 and the contacts 17 in the module 10. As a result, the module 10 may be recharged from a power source in the base unit 30 in some embodiments.

The base unit 30 then extracts the PIN information and the credit card information. The extracted information is provided over the input/output connector 40 to an appropriate credit card processing entity together with the amount of the transaction.

The credit card processing entity then compares the personal identification number and the credit card number. If the personal identification number is associated with the credit card number in the credit processor's records, the transaction may be approved subject to other considerations. For example, as is conventional, the credit card processor may decline the transaction if the credit card owner has exceeded his or her credit limits.

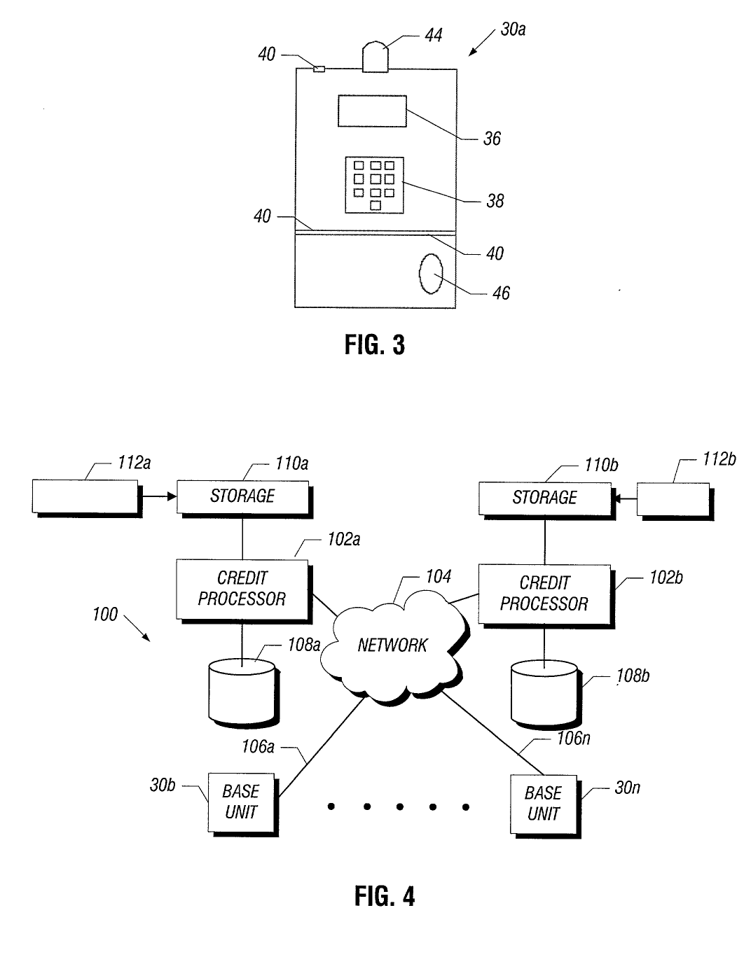

Turning next to FIG. 3, the base unit 30a may be adapted for a different application than the base unit 30. For example, the base unit 30a may be utilized in a situation where the credit card owner approaches the cashier to initiate the transaction. In such case, it may not be necessary to utilize a hand module 10 and instead, the cashier may swipe the credit card and then provide the unit 30a to the purchaser to confidentially enter his or her PIN number using the keypad 36. Again, a start button 46, a printer 44 and an input/output connector 40 may be provided in the unit 30a. In some embodiments, a slot 40 for swiping credit cards and reading credit cards may be provided directly on the unit 30a.

As shown in FIG. 4, a plurality of base units 30b-30n may be coupled through a network 104 with one or more credit processors 102a and 102b. In some embodiments, the network 104 may be implemented by a conventional telephone network. In other embodiments, the network 104 may be provided through a computer network such as the Internet.

In some embodiments, the base unit 30a may be coupled to the network 104 through wired or wireless network connections 106a-106n. Each credit card processor 102a or 102b may be coupled to a database 108 and a storage 110. Software 112 may be stored on the storage 110.

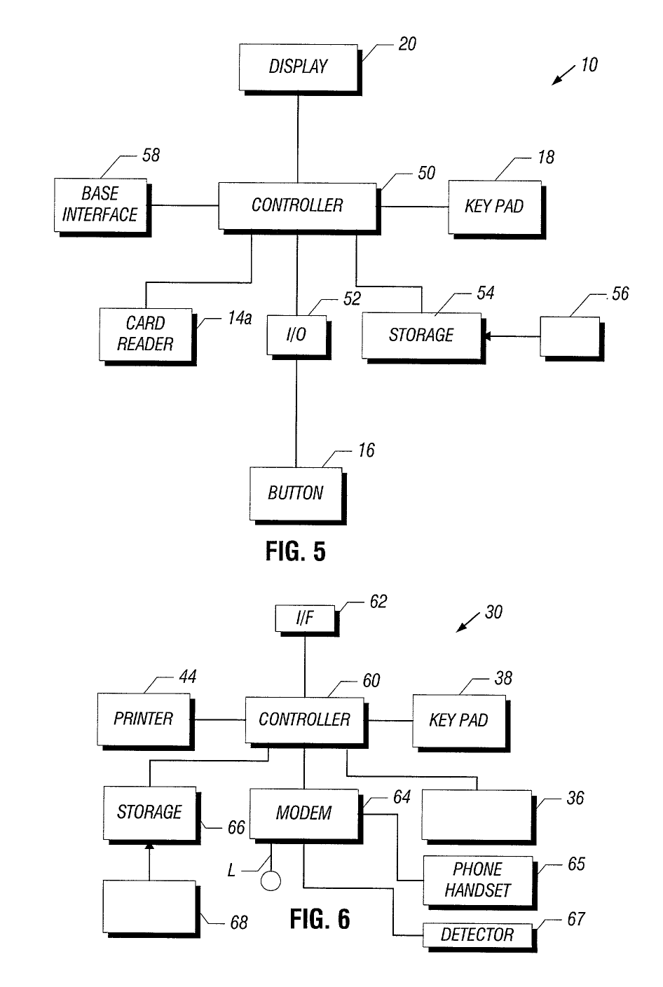

Referring now to FIG. 5, a hand module 10, in accordance with one embodiment of the present invention, may include a controller 50 which may be a microcontroller or a microprocessor in some embodiments. Coupled to the controller 50 may be a display 20 and a keypad 18 as described previously. A card reader 14a may also be coupled to the controller 50 for reading the magnetic stripes on credit cards swiped through the slot 14. A storage 54 may be a flash memory, in one embodiment, that stores a software program 56. An input/output interface 52 may receive signals from the start button 16. Finally, a base unit interface 58 may interface through the receptacle 32 with the base unit 30.

Referring to FIG. 6, the base unit 30 includes a hand module interface 62 for interfacing with the hand module 10 plugged into a receptacle 32. A controller 60 may also be a microcontroller or a microprocessor. The controller 60 is coupled to a keypad 38, display 36 and a printer 44 in some embodiments. A modem 64 or other interface may be provided for interfacing the base unit 30 with the network 104 over the link 106. The storage 66, which may be a semiconductor memory or a hard disk drive as two examples, may store software 68.

The embodiment shown in FIG. 3 may be implemented by components shown in FIGS. 5 and 6 which may be combined into one unit, eliminating the duplicate interfaces 58 and 62, duplicate controllers 50 and 60, the duplicate storage units 54 and 66, duplicate displays 20 and 36 and duplicate keypads 18 and 38.

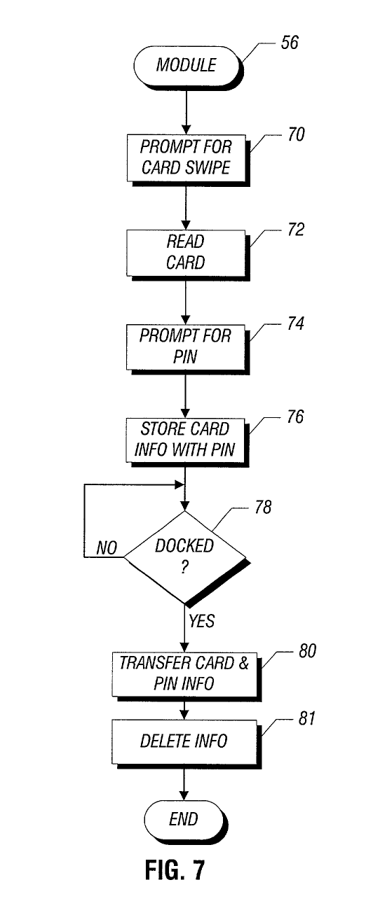

Moving to FIG. 7, the software 56 on the module 10 may initially prompt the user to swipe a credit card as indicated in block 70. The module 10 may prompt the user by providing a display on the screen 20 in one embodiment. When swiped, the magnetic stripe on the credit card is read, as indicated in block 72. The module 10 may then prompt the user to enter his or her personal identification number, as indicated in block 74. Again, the prompt may be implemented using the display screen 20 in one embodiment. Once the user enters the PIN, the card information contained on the magnetic stripe may be stored together with the PIN information, as indicated in block 76, for example on the storage 54, in one embodiment.

When the module 10 is docked in a receptacle 32 on the base unit 30, a check at diamond 78 so indicates. The detection of docking may occur because a switch in the receptacle 32 may be closed in one embodiment. This provides a signal to the module 10 to transfer the card and personal identification information to the base unit 30 as indicated in block 80 in accordance with one embodiment. Thereafter, in some embodiments, the information on the module 10 may be automatically deleted as indicated in block 31 to prevent misuse of this information.

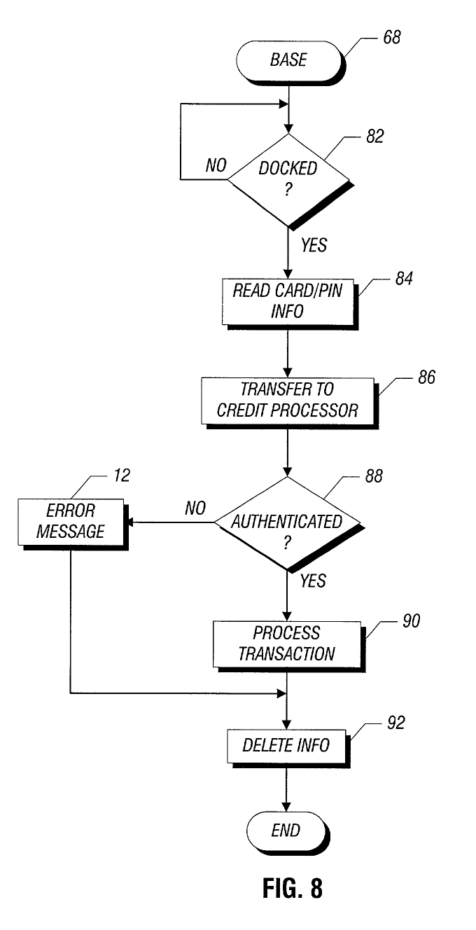

Turning next to FIG. 8, the base unit software 68 then takes over the processing of the credit card transaction. The base unit 68 detects the docking, as indicated in diamond 82, and reads the card and personal identification information from the module 10 as indicated in block 84. That information is then automatically transferred to a credit processor in accordance with one embodiment of the present invention as indicated in block 86. This transfer may be initiated by automatically dialing a telephone number to transfer the information or by providing the information over the Internet in a secure fashion, to mention two examples. Eventually, the base unit 30 receives a response from the credit processor if the transaction is approved or authenticated as determined in diamond 88, the transaction is processed conventionally as indicated in block 90. Otherwise, an error message may be displayed on the screen 36. In any case, the credit card information and the personal identification number is automatically deleted from the base unit 30, as indicated in block 92.

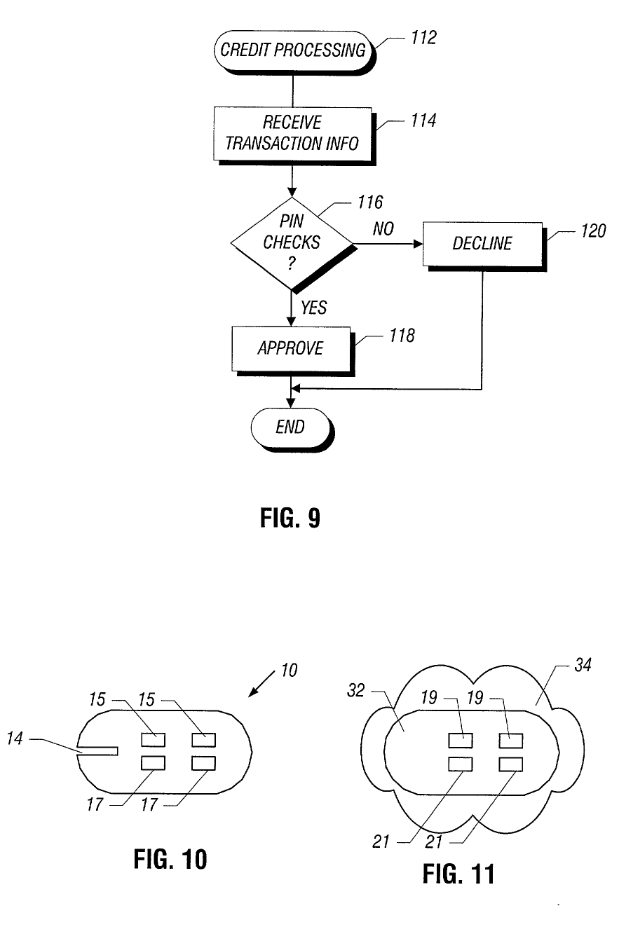

Finally, as shown in FIG. 9, the credit card processing software 112 associated with the credit processor 102 receives the transaction information from the base unit 30 over the network 104, as indicated in block 114. The credit processor 102 consults a database 108 to determine whether or not the personal information number matches the credit card number as indicated in diamond 116. If so, the transaction may be approved, as indicated in block 118. In some embodiments, other credit worthiness information may also be checked in order to determine whether to approve the transaction. However, if the personal information number does not match the credit card, the transaction may be declined as indicated in block 120.

Referring back to FIG. 6, in accordance with another embodiment of the present invention, the modem 64 may receive inputs from a telephone line in addition to providing outputs to a remote service provider such as a credit processor. In an alternative embodiment, the modem 64 may be connected to a telephone line “L”. The base unit 30 may include a telephone handset 65 so that the retailer can monitor a phone conversation with a customer. The customer may be asked to provide his or her credit card number by the seller. The customer may respond by pressing the telephone handset buttons to enter a credit card number.

When the modem 64 receives an input that corresponds to a plurality of tones, the detector 67 may detect those tones and may convert them into credit card number information. The retailer or seller may be unable to detect the credit card information unless it is actually displayed on the display 36.

Next the purchaser may be asked to provide a PIN by pressing the buttons on the customer's telephone handset. The modem 64 may receive that input and a controller 60 may convert that input into a digital form of the user's personal information number. The PIN information may not be displayed on the screen 36 (or may be simply displayed as asterisks to allow the seller to know that the PIN has been received). Once the information has been received, the credit card number and PIN can be processed by transmitting them to a credit card processor as described previously.

Thus, in accordance with the alternate embodiment, the customer is able to provide a input through the modem 64 in the form of a plurality of telephone pushbutton actuations. The pushbutton actuations generate tones that may be detected through the controller 60 that converts those tones into credit card information including a personal information number. As a result, telephone sales transactions may be made more secure.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving information identifying a particular credit card;
receiving a code associated with the owner of a credit card;
determining whether or not the code matches the credit card information; and
processing the transaction if the code matches the credit card information.

2. The method of claim 1 wherein receiving a code includes receiving a personal identification number.

3. The method of claim 1 including declining the transaction if the code does not match the credit card information.

4. A module comprising:
a card reader to read the magnetic stripe on a credit card;
a keypad to enter a code associated with the owner of a credit card; and
an interface to transfer the code and information from the credit card.

5. The module of claim 4 wherein said module is portable and sized to fit in a user's hand.

6. The module of claim 4 wherein said module includes a display to display information entered on said keypad.

7. The module of claim 4 including a processor and a storage coupled to said processor, said storage storing instructions to prompt the user to swipe a credit card.

8. The module of claim 4 wherein said module includes a processor and a storage coupled to said processor, said storage storing instructions to prompt the user to enter the code.

9. The module of claim 4 wherein said module includes a processor and storage coupled to said processor, said storage including instructions to determine when the module is docked at a docking station and to automatically transfer said code and credit card information to said station when said module is docked.

10. An article comprising a medium storing instructions to enable a processor-based system to:
receive information identifying a particular credit card;
receive a code associated with the owner of the credit card; and
transfer said code and said credit card information.

11. The article of claim 10 further storing instructions that enable the processor-based system to prompt the user to enter said code.

12. The article of claim 10 further storing instructions that enable the processor-based system to prompt the user to swipe a credit card.

13. A base unit comprising:
a housing;
at least one receptacle on said housing to plugingly receive a module;
a processor in said housing; and
a storage associated with said processor, said storage storing instructions to enable said processor to transfer credit card information and a user identifying code received from a module plugged into said receptacle.

14. The base unit of claim 13 including a plurality of receptacles.

15. The base unit of claim 13 including an interface to transfer information about the user identifying code and the credit card information to a credit card processor.

16. The base unit of claim 13 including a display screen and a keypad.

17. An article comprising a medium storing instructions that enable a processor-based system to:
determine whether or not a hand-held module is docked in a base unit;
read data from the hand-held unit including information from a credit card and a personal information number; and
transfer the data to a credit card processor.

18. The article of claim 17 wherein said medium stores instructions that enable the processor-based system to receive information from the credit card processor about whether or not a given transaction is approved.

19. The article of claim 18 further storing instructions that enable the processor-based system to delete the data received from the hand-held unit.

20. An article comprising a medium storing instructions that enable a processor-based system to:
receive information about a credit card and a personal information number associated with a particular credit card user;
determine whether the credit card information and the personal information number information matches; and
process a credit card transaction depending on whether or not the personal information number and the credit card information match.

21. A method comprising:
receiving code identifying the owner of the credit card as a sequence of signals generated by pressing telephone buttons; and
using said code to authenticate a credit card transaction.

22. The method of claim 21 including receiving credit card number information as a sequence of signals generated by pressing telephone buttons.

23. The method of claim 22 including comparing said code and said credit card number information.

24. The method of claim 23 including converting said signal sequences to electronic data indicative of a credit card number and a personal identification number.

25. The method of claim 24 including enabling voice communications over the phone line used to convey said sequences of signals.
